(19) United States
(12) Patent Application Publication
(10) Pub. No.: US 2010/0221582 A1
(43) Pub. Date: Sep. 2, 2010

(54) MAGNETIC RECORDING MEDIUM SUBSTRATE AND MAGNETIC RECORDING MEDIUM

(76) Inventors: Hideki Kawai, Hyogo (JP); Kouichi Takikawa, Aichi (JP); Shigeru Hosoe, Tokyo (JP); Satoshi Nakano, Tokyo (JP); Hiroyuki Hattori, Tokyo (JP); Yoshiharu Masaki, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/159,175

(22) PCT Filed: Dec. 13, 2006
(86) PCT No.: PCT/JP2006/324833

§ 371 Date: Jun. 25, 2008

(30) Foreign Application Priority Data
Dec. 28, 2005 (JP) 2005-377112

(51) Int. Cl. G11B 5/706

(52) U.S. Cl. 428/846; 428/848.5

(57) ABSTRACT

Provided is a magnetic recording medium substrate appropriate for a discrete medium and capable of fabricating a magnetic recording medium to/from which data can be written or read stably. Coaxial grooves (2) are formed on the surface of a resin substrate (1). The groove (2) has a width (T2) greater than a width (T1) of a track (3). Accordingly, when a magnetic layer is layered on the resin substrate (1), magnetic layers formed on the adjacent tracks (3) are not brought into contact and it is possible to prevent the problem that the magnetic layer is embedded in the groove (2). Thus, it is possible to physically separate the track (3) by the groove (2) and fabricate a magnetic recording medium to/from which data can written and read stably.

### FIELD OF THE INVENTION

The present invention relates to a substrate to be included in a magnetic recording medium and a magnetic recording medium utilizing said substrate to be included in a magnetic recording medium, and particularly relates to a substrate to be included in a magnetic recording medium employing a non-magnetic substrate the surface of which is comprised of resin, and a magnetic recording medium utilizing said substrate to be included in a magnetic recording medium.

### BACKGROUND OF THE INVENTION

There is a tendency that a recording capacity of a magnetic recording device such as a hard disc drive device is increased and a vertical recording method is being brought in practical use.

This vertical recording method is a recording method to record by vertical magnetization against the interior plane of a recording layer of a magnetic recording medium, and is capable of recording at a high density. However, in a vertical recording method, there is a problem of a recording failure or a reproduction failure due to a writing action on the adjacent tracks by side fringing generated from the side surface of a magnetic head in the case of a recording density of not less than 100 Gbt/in².

Therefore, a so-called discrete medium (hereinafter, referred to as “a DT medium”), in which a groove is formed along the circumferential direction of a magnetic recording medium and the inter-track is physically separated by a non-magnetizing region (a non-recording region) where writing is impossible, is proposed (for example, refer to patent documents 1 and 2). According to this DT medium, it is possible to avoid such problems that data are written in the adjacent tracks by mistake at the time of recording, that data may be read out from the adjacent tracks by mistake at the time of reproduction and that out put power reduction due to a signal noise generated by magnetization bent at the recording bit edge, whereby problems characteristic to a magnetic recording medium having a high density recording capability can be avoided.

Patent document 1: JP-A 5-28488 (hereinafter, JP-A refers to Japanese Patent Publication Open to Public Inspection No.)

Patent document 2: JP-A 2005-293633

### SUMMARY OF THE INVENTION

### Problems to be Solved by this Invention

However, a substrate of a flat plate form non-magnetic material is utilized in a conventional DT medium and it is necessary to accumulate a soft magnetic layer and a magnetic layer on said substrate of a non-magnetic material and to conduct patterning by means of such as a nano-inprint method, a photolithographic method and an electron drawing method in fabrication of a DT medium. Such a patterning process is complicated and has a problem of significant cost up in a fabrication process for a magnetic recording material which requires formation of a great amount of recording capacity of a large area.

Further, a DT medium employing a plastic substrate provided with a molded groove by one-shot molding is proposed; however, a magnetic recording medium in/from which data can be written or read more stably is desired.

This invention will solve the above-described problem and the object is to provide a substrate to be included in a magnetic recording medium suitable for a DT medium and capable of being easily fabricated without requiring a complex process. Further, provided is a substrate to be included in a magnetic recording medium capable of fabricating a magnetic recording medium in/from which data can be written and read stably. Further, an object of this invention is also to provide a magnetic recording medium utilizing the aforesaid substrate to be included in a magnetic recording medium.

### Means to Solve the Problems

The inventors according to this application have found that, in consideration of the relationship between a width of a groove formed on a substrate to be included in a magnetic recording medium utilized for a DT medium and a width of the convex top constituting a surface recording bit track, by forming coaxial grooves on a non-magnetic substrate the surface of which is comprised of resin and the relationship between a width of a groove and appropriately controlling a width of a track, magnetic layers formed on the adjacent tracks are not brought into contact and it is possible to prevent the grooves being embedded with a magnetic layer, in the case of forming a magnetic layer on the substrate. As a result, by utilizing a substrate to be included in a magnetic recording medium of this invention, it is possible to fabricate a magnetic recording medium in/from which data can be written in and read out stably.

The first embodiment of this invention is a substrate to be included in a magnetic recording medium having a disc form and a surface of the substrate is made of a resin, the substrate comprising: a non-magnetic material as a base material; wherein a plurality of coaxial grooves are formed on the surface, and the plurality of coaxial grooves satisfies the expression

T₂/5<T₁<5T₂

where T₁ is a width of an interval between adjacent grooves of the coaxial grooves and T₂ is a width of each of the coaxial grooves.

The second embodiment of this invention is the substrate to be included in a magnetic recording medium according to the first embodiment, wherein d/5<T₁<5d is satisfied when a depth of each of the coaxial grooves is d.

The third embodiment of this invention is the substrate to be included in a magnetic recording medium according to either of the first or second embodiment, wherein T₃≦T₂ (herein, T₃=0 is included) is satisfied where a width of an upper part of each of the coaxial grooves is T₂ and a width of a bottom part of each of the coaxial grooves is T₃.

The forth embodiment of this invention is the substrate to be included in a magnetic recording medium according to either of the first or second embodiment, wherein the width of each of the coaxial grooves is made gradually narrower from the surface to the interior of the substrate.

The fifth embodiment of this invention is the substrate to be included in a magnetic recording medium according to either of the first or second embodiment, wherein the side surfaces of each of the coaxial grooves is a flat plane crossing straight against the surface of the substrate.

The sixth embodiment of this invention is the substrate to be included in a magnetic recording medium according to any one of the first to forth embodiments, wherein at least one side surface of each of the coaxial grooves is inclined with respect to the surface of the substrate.

The seventh embodiment of this invention is the substrate to be included in a magnetic recording medium according to the sixth embodiment, wherein an inclination angle of the inclined side surface is from 45° to 90°.

The eighth embodiment of this invention is the substrate to be included in a magnetic recording medium according to either of the sixth or seventh embodiment, wherein a curved surface is intervened between the side surface of each of the coaxial grooves and the surface of the substrate.

The ninth embodiment of this invention is the substrate to be included in a magnetic recording medium according to any one of the first to forth embodiments, wherein the side surface of each of the coaxial grooves has a curved surface form.

The tenth embodiment of this invention is the substrate to be included in a magnetic recording medium according to the ninth embodiment, wherein the side surface having a curved surface form is a curved surface having a convex surface form.

The eleventh embodiment of this invention is the substrate to be included in a magnetic recording medium according to the ninth embodiment, wherein the side surface having a curved surface form is a curved surface having a concave surface form.

The twelfth embodiment of this invention is the substrate to be included in a magnetic recording medium according to any one of the first to tenth embodiments, wherein T₁/2<TW<T₁+2T₂ is satisfied in a magnetic recording device mounted with the substrate when a line width of a writing line of a magnetic head equipped in the magnetic recording device is TW.

The thirteenth embodiment of this invention is the substrate to be included in a magnetic recording medium according to any one of the first to twelfth embodiments, wherein the coaxial grooves are divided by a predetermined uneven pattern at a predetermined position in a circumferential direction of the substrate.

The fourteenth embodiment of this invention is the substrate to be included in a magnetic recording medium according to the thirteenth embodiment, wherein grooves and uneven patterns are formed on the both surfaces of the substrate.

The fifteenth embodiment of this invention is the substrate to be included in a magnetic recording medium according to the fourteenth embodiment, wherein the grooves and the uneven patterns, which are formed on the both surfaces of the substrate, are formed at symmetric positions with respect to a center in a thickness direction of the substrate as an axis.

The sixteenth embodiment of this invention is the substrate to be included in a magnetic recording medium according to the fourteenth embodiment, wherein positions of the grooves and the uneven patterns, which are formed on the both surfaces of the substrate, coincide.

The seventeenth embodiment of this invention is the substrate to be included in a magnetic recording medium according to the fourteenth embodiment, wherein the grooves and the uneven patterns, which are formed on the both surfaces of the substrate, are formed at asymmetric positions with respect to a center in a thickness direction of the substrate as an axis.

The eighteenth embodiment of this invention is the substrate to be included in a magnetic recording medium according to the fourteenth embodiment, wherein positions of the grooves and the uneven patterns, which are formed on the both surfaces of the substrate, do not coincide.

The nineteenth embodiment of this invention is the substrate to be included in a magnetic recording medium according to any one of the first to eighteenth embodiments, wherein the substrate satisfies the expression

TRa<SRa≦BRa

where TRa is a surface roughness at a place between the coaxial grooves, SRa is a surface roughness on the side surface of the coaxial grooves and BRa is a surface roughness at the bottom of the coaxial grooves.

The twentieth embodiment of this invention is the substrate to be included in a magnetic recording medium according to the nineteenth embodiments, wherein the substrate satisfies the expression

TRa<2 nm, SRa<10 nm and BRa<10 nm.

The twenty-first embodiment of this invention is the substrate to be included in a magnetic recording medium according to any one of the first to twentieth embodiments, wherein cross-sectional form of each of the coaxial grooves is asymmetric against an axis passing through the center of the groove.

The twenty-second embodiment of this invention is the substrate to be included in a magnetic recording medium according to any one of the first to twenty-first embodiments, wherein an winding value Wa of the surface of the substrate is not more than 30 Å.

The twenty-third embodiment of this invention is the substrate to be included in a magnetic recording medium according to any one of the first to twenty-second embodiments, wherein a micro-winding value MWa of the surface of the substrate is not more than 30 Å.

The twenty-fourth embodiment of this invention is the substrate to be included in a magnetic recording medium according to any one of the first to twenty-third embodiments, wherein the coaxial grooves are formed by a molding method.

The twenty-fifth embodiment of this invention is the substrate to be included in a magnetic recording medium according to any one of the first to twenty-third embodiments, wherein the coaxial grooves are formed by a patterning method.

The twenty-sixth embodiment of this invention is the substrate to be included in a magnetic recording medium according to any one of the first to twenty-fifth embodiments, wherein a cover layer of not less than 10 nm and not more than 300 nm is formed on the substrate.

The twenty-seventh embodiment of this invention is the substrate to be included in a magnetic recording medium according to the twenty-sixth embodiments, wherein the substrate satisfies the expression

Tc<3d

where Tc is a thickness of a cover layer and d is a depth of each of the coaxial grooves.

The twenty-eighth embodiment of this invention is the substrate to be included in a magnetic recording medium according to any one of the first to twenty-seventh embodiments, wherein the non-magnetic material as the base material is comprised of resin.

The twenty-ninth embodiment of this invention is the substrate to be included in a magnetic recording medium according to any one of the first to twenty-seventh embodiments, wherein the non-magnetic material as the base material is comprised of glass or a non-magnetic metal material.

The thirtieth embodiment of this invention is a magnetic recording medium, comprising: the substrate to be included in a magnetic recording medium according to any one of the first to twenty-ninth embodiments of this invention; and a magnetic layer accumulated on the substrate.

### EFFECTS OF THE INVENTION

According to this invention, it is possible to prevent the problem that a groove is embedded with a magnetic layer in the case of accumulating a magnetic layer on a substrate to be included in a magnetic recording medium. Thereby, a substrate to be included in a magnetic recording medium according to this invention is capable of fabricating a magnetic recording medium in/from which data can be written and read out stably.

Further, by forming a groove on a substrate to be included in a magnetic recording medium, patterning of a magnetic layer by means of such as a nano-inprint method is not required and it is possible to fabricate a magnetic recording medium in a process number less than a conventional process number.

Further, since it is possible to fabricate a magnetic recording medium having a groove formed by a molding method such as an extrusion molding method, possible is easy fabrication of a magnetic recording medium provided with a different form of a groove by controlling the molding by preparation of a molding die.

### BRIEF DESCRIPTION OF THE DRAWINGS

FIG. 1 is a cross-sectional view of a substrate to be included in a magnetic recording medium according to an embodiment of this invention.

FIG. 2 is a cross-sectional view of a substrate to be included in a magnetic recording medium according to an embodiment of this invention.

FIG. 3 is a cross-sectional view of a substrate to be included in a magnetic recording medium according to a modified example 1.

FIG. 4 is a cross-sectional view of a substrate to be included in a magnetic recording medium according to a modified example 1.

FIG. 5 is a cross-sectional view of a substrate to be included in a magnetic recording medium according to a modified example 2.

FIG. 6 is a cross-sectional view of a substrate to be included in a magnetic recording medium according to a modified example 3.

FIG. 7 is a cross-sectional view of a substrate to be included in a magnetic recording medium according to a modified example 4.

### DESCRIPTION OF THE SYMBOLS

1, 1A, 1B, 1C, 1D, 1E: substrate made of resin
2, 2A, 2B, 2C: groove
3, 3A, 3B, 3C: track
4: magnetic layer
5: magnetic head

### DETAILED DESCRIPTION OF THE INVENTION

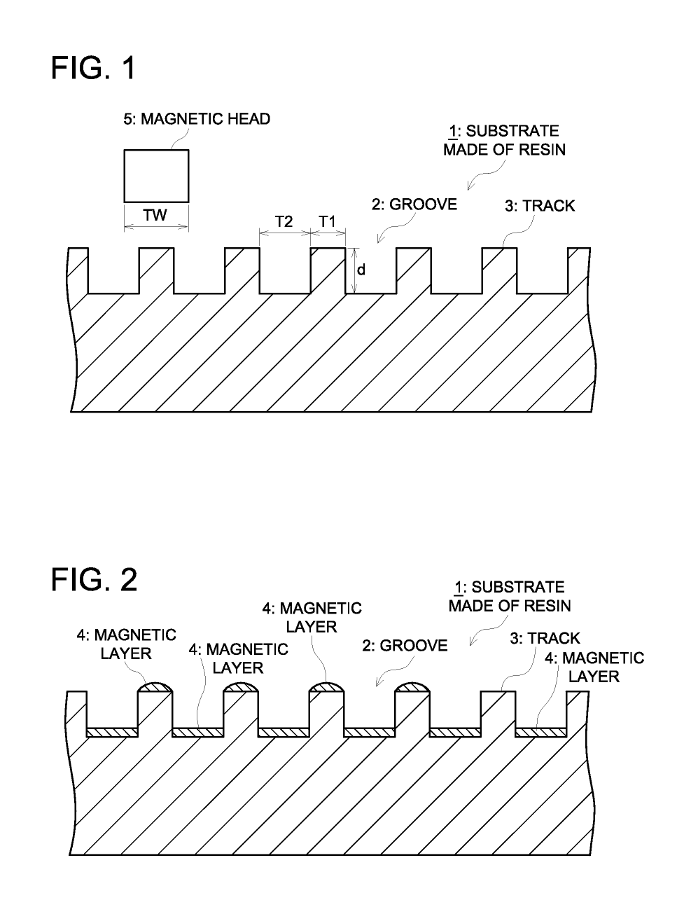

A substrate to be included in a magnetic recording medium according to an embodiment of this invention will be explained in reference to an example of a substrate to be included in a magnetic recording medium of FIG. 1 and FIG. 2. FIG. 1 and FIG. 2 are cross sectional views of a recording medium substrate according to an embodiment of this invention.

Substrate made of resin 1 has a disk form and is provided with a hole at the center to be utilized as a substrate of a magnetic recording medium such as a hard disc. This substrate made of resin 1 corresponds to a substrate to be included in a magnetic recording medium of this invention. Grooves are coaxially formed at every predetermined interval on the surface of substrate made of resin 1.

FIG. 1 is a drawing to show a cross-sectional view along the radius direction of substrate made of resin 1. As shown in the cross-sectional view of FIG. 1, grooves 2 are formed at every interval on the surface of substrate made of resin 1. Track 3 is formed at the portion between groove 2 and groove 2. That is, track 3 is formed on the portion where the surface of substrate made of resin 1 remains as it is without arranging groove 2.

Herein, a width of track 3 is T₁, a width of groove 2 is T₂ and a depth of groove 2 is d. In this embodiment, the side surface of groove 2 is vertically formed against the top surface of track 3 (the surface of substrate made of resin 1), width T₂ of groove 2 being constant in the depth direction of substrate made of resin 1, and width T₁ of track 3 is also constant in the depth direction. Therefore, a width of the top portion of groove 2 and a width of the bottom surface of groove 2 are identical.

In substrate made of resin 1 according to this embodiment, width T₁ of track 3 and width T₂ of groove 2 satisfy the following relationship of equation (1).

T₂/5<T₁<5T₂ Equation (1)

As described above, by setting width T₁ of track 3 narrower than 5 times of width T₂ of groove 2, it is possible to prevent a magnetic layer or a cover layer from being embedded in grove 2 when a magnetic layer or a cover layer is formed on the surface of substrate made of resin 1. By employing substrate made of resin 1 of this embodiment, it is possible to fabricate a magnetic recording medium in/from which data can be written and read stably.

Further, since a sufficient recording track region can be secured by setting width T₁ of track 3 to be broader than one fifth of width T₂ of groove 2, it is possible to fabricate a magnetic recording medium having a stable magnetic recording and reproducing characteristics without decreasing recording capacity.

This effect will now be explained in reference to FIG. 2. As shown in FIG. 2, in the case of forming magnetic layer 4 on the surface of substrate made of resin 1, magnetic layer 4 is formed in groove 2 in addition to on track 3. In the case of a width of the track is broader than 5 times of a width of the groove, there is a possibility that magnetic layers on the adjacent tracks may contact each other to cover the top of the groove. When the groove has been covered in this manner, an essential function of a groove to physically separate tracks is not exhibited and there may be caused a problem that data may be written in the adjacent tracks at recording or data may be read from the adjacent tracks at reproduction.

On the other hand, in substrate made of resin 1 according to this embodiment, since width T₁ of track 3 is narrower than 5 times of width T₂ of groove 2, there is no risk of contact between magnetic layers 4 on adjacent tracks 3 each other, nor groove 2 being embedded with such as a magnetic layer. Therefore, an essential function of groove 2 is exhibited to enable physical separation of tracks 3. As a result, when a magnetic recording medium is fabricated utilizing substrate made of resin 1 according to this embodiment, it is possible to stably perform read-out and write-in of data.

Further, by setting width T₁ of track 3 to be broader than one fifth of width T₂ of groove 2, a sufficient recording track region can be secured on the recording surface to compensate capacity decrease accompanied with a practical recording area due to groove introduction, whereby a sufficient improvement effect of recording density, which has been achieved by an essential function of a groove to physically separate tracks, is exhibited.

For example, it is preferable to make width T₁ of track 3 of 0.005-5 μm and width T₂ of groove 2 of 0.001-25 μm, and groove 2 is formed so as to satisfy the relationship of above-described equation (1) in this range of the width.

Further, width T₁ of track 3 and depth d of groove 2 preferably satisfy the relationship of following equation (2).

d/5<T₁<5d Equation (2)

As described above, by making width T₁ of track 3 of narrower than 5 times of depth d of groove 2, groove 2 is never embedded with a magnetic layer or a cover layer in the case of forming a magnetic layer or a cover layer on the surface of substrate made of resin 1. Thereby, provided can be a magnetic recording medium in/from which data can be written and read more stably. Further, since a distance between a magnetic head and a magnetic layer accumulated in groove 2 is prolonged, it is possible to decrease influence of noise arising from a magnetic layer accumulated in groove 2.

Further, by making width T₁ of track 3 of broader than one fifth of depth d of groove 2, it is possible to secure good productivity at the time of processing of a groove and to secure a sufficiently broad track width against a depth of the groove, whereby it is possible to achieve a processing state of a groove exhibiting stable strength and high reliability.

For example, it is preferable to make a depth of a groove of 0.001-25 μm and groove 2 is formed so as to satisfy the relationship of above-described equation (2) within this depth range.

Further, width T₁ of track 3 and width T₂ of groove 2 preferably satisfy the relationship of following equation (3), when a width of a writing line of a magnetic head of a magnetic recording medium utilizing substrate made of resin 1 according to this embodiment is TW.

T₁/2<TW<T₁+2T₂ Equation (3)

Herein, as shown in FIG. 1, width of a writing line TW of magnetic head 5 corresponds to a magnetic pole width of magnetic head 5 along the track width direction.

By satisfying the relationship of equation (3), it is possible to fabricate a magnetic recording medium capable of stable write-in of data while preventing write-in to the adjacent tracks 3.

Next, a material of substrate made of resin 1 will be explained. In substrate made of resin 1, variety of resin in addition to thermoplastic resin, thermosetting resin or actinic ray curable resin can be utilized.

For example, in substrate made of resin 1, as thermoplastic resin, such as polycarbonate, polyether ether ketone resin (PEEK), cyclic polyolefin resin, methacryl styrene resin (MS resin), polystyrene resin (PS resin), polyether imide resin (PEI resin), ABS resin, polyester resin (such as PET resin and PBT resin), polyolefin resin (such as PE resin and PP resin), polysulfone resin, polyether sulfone resin (PES resin), polyallylate resin, polyphenylene sulfide resin, polyamide resin or acrylic resin can be utilized. As thermosetting resin, such as phenol resin, urea resin, unsaturated polyester resin (such as BMC resin), silicone resin, urethane resin, epoxy resin, polyimide resin, polyamideimide resin or polybenzoimidazole resin can be utilized. In addition to these, such as polyethylene naphthalate resin (PEN resin) can be utilized.

Further, as actinic ray curable resin, for example, ultraviolet ray curable resin can be utilized. Ultraviolet ray curable resin includes such as ultraviolet curable acrylurethane type resin, ultraviolet curable polyester acrylate type resin, ultraviolet curable epoxy acrylate type resin, ultraviolet curable polyole acrylate type resin, ultraviolet curable epoxy resin, ultraviolet curable silicone type resin or ultraviolet curable acrylic resin.

To make the object of this invention be effectively exhibited, it is preferable to promote a curing reaction by employing a photoinitiator when a coated layer before curing is irradiated with actinic rays. At this time, a photosensitizer may be utilized together.

Further, in the case that oxygen in the air restrains the above-described reaction, it is also possible to irradiate actinic rays in such as an inert gas atmosphere to decrease or eliminate oxygen concentration. As actinic rays, such as infrared rays, visible light and ultraviolet rays can be appropriately selected, and ultraviolet rays are specifically preferably selected, however, they are not limited thereto. Further, during, before or after irradiation of actinic rays, the curing reaction may be enhanced by heating.

Further, in substrate made of resin 1, such as liquid crystal polymer and organic/inorganic hybrid resin (for example, those adopting silicon as a skeleton into a polymer component) can be utilized. Herein, resin listed above is an example of resin utilized in substrate made of resin 1 and a substrate made of resin according to this invention is not limited thereto. At least two types of resin can be mixed to be a substrate made of resin, and different components as separate layers may be adjacently arranged to constitute a substrate.

Substrate made of resin 1 can be fabricated, by use of a molding die having a form corresponding to substrate made of resin 1, by means of a molding method such as an extrusion molding method, an injection molding method, a sheet molding method, an extrusion compression molding method or a compression molding method. That is, substrate made of resin 1 is fabricated, by use of a molding die having a form corresponding to groove 2 and track 3 of substrate made of resin 1, by means of such as an extrusion molding method. Further, a substrate molded may be appropriately subjected to cutting and punching, or to press molding to fabricate substrate made of resin 1.

In this manner, since groove 2 can be formed on substrate made of resin 1 by a molding method, it is possible to form a magnetic layer necessary for magnetic recording by means of such as a spattering method without requiring patterning by such as a nano-inprint method. Thereby, a magnetic recording medium can be fabricated with a process number less than a conventional process number.

Further, by molding substrate made of resin 1 by such as the above-described extrusion molding method, it is possible to simultaneously mold at least one of the dimension of an inner circumference, the dimension of an outer circumference, the edge portion form of an inner circumference or the edge portion form of an outer circumference. That is, by preparing a molding die utilized in an extrusion molding method so as to fit the inner diameter or to the outer diameter of substrate made of resin 1 and employing said molding die, the dimension of the inner diameter or the outer diameter is completed at the time of resin molding. Further, by preparing a molding die utilized in an extrusion molding method so as to fit the edge portion form of an inner circumference or to the edge portion form of an outer circumference of substrate made of resin 1 and employing said molding die, the edge portion form of an inner circumference or the edge portion form of an outer circumference is completed at the time of resin molding.

Further, substrate made of resin 1 according to this embodiment can be fabricated by a method other than a molding method. For example, resist is provided on a substrate having a flat plate form, a pattern being formed on the resist by use of a mask corresponding to groove 2, and groove 2 is formed on the substrate by irradiation with a laser such as an excimer laser. Thereafter, resist on a substrate is peeled off to prepare substrate made of resin 1. In this manner, substrate made of resin 1 may be fabricated via a patterning process.

In the case of fabricating a magnetic recording medium by use of this substrate made of resin 1, a magnetic layer comprising Co type alloy is formed on the surface of substrate made of resin 1 by such as spattering to prepare a magnetic recording medium. Further, a cover layer may be formed on the surface of substrate made of resin 1 and a magnetic layer may be formed on said cover layer. A thickness of this cover layer is preferably 10-300 nm. Herein, the relationship with a depth of groove 2 preferably satisfies Tc<3d, when a thickness of a cover layer is Tc.

As a cover layer, a metal layer, a ceramic layer, a magnetic layer, a glass layer or a complex layer (a hybrid layer) of an inorganic layer and an organic layer is utilized. A specific component of a cover layer includes such as Ni (nickel), Fe (iron), Cu (copper), Ti (titanium), P (phosphorus), Co (cobalt), Si (silicon), Sn (tin) or Pd (Palladium).

A cover layer can be formed on the surface of substrate made of resin 1 by a plating method such as electric plating or chemical plating. In addition to these, a cover layer can be formed also by spattering, vacuum evaporation or a CVD method. Further, employed can be a coating method such as a bar coat method, a dip coat (immersion and pulling up) method, a spin coat method, a spray method or a printing method.

Further, in a vertical magnetic recording medium which is greatly expected as a technology for higher density, a magnetic substance has to be arranged vertically against the substrate surface, which requires formation of a soft magnetic layer between the magnetic layer and the substrate. A typical alloy for this soft magnetic layer includes nickel-cobalt (Ni—Co) alloy. By employing Ni—Co alloy as a cover layer, said cover layer can also perform a function as a soft magnetic layer in a vertical magnetic recording medium.

Further, resin as a mother material preferably has as high heat-resistant temperature or glass transition temperature Tg as possible. Since a magnetic layer is formed by spattering on substrate made of resin 1, the heat-resistant temperature or glass transition temperature Tg is preferably not lower than the temperature at spattering. For example, it is preferable to utilize resin having a heat-resistant temperature or glass transition temperature Tg of not lower than 200° C.

Typical resin having glass transition temperature Tg of not lower than 200° C. includes such as polyether sulfone resin (PES resin), polyether imide resin (PEI resin), polyamideimide resin, polyimide resin, polybenzoimidazole resin, BMC resin or liquid crystal polymer. More specifically listed are Udel (Solvay Advanced Polymers K.K.) as polyether sulfone resin (PES resin), Ultem (Nippon GE Plastic) as polyether imide (PEI resin), Torlon (Solvay Advanced Polymers K.K.) as polyamideimide resin, Aurum (Mitsui Chemicals, Inc.) as polyimide resin (thermoplastic), Upilex (Ube Industries, Ltd.) as polyimide (thermosetting) or PBI/Celazole (Client Japan) as polybenzoimidazole resin. Further, listed are Sumica Super LCP (Sumitomo Chemical Co., Ltd.) as liquid crystal polymer and Pictolex (Pictolex Mc) as polyether ketone.

Further, as substrate made of resin 1, resin having a small moisture absorptive property is preferably selected to prevent positional deviation from a magnetic head due to dimension variation of a substrate by moisture absorption. A typical resin having a small moisture absorptive property includes polycarbonate and cyclic polyolefin resin.

Further, when a surface roughness of the top surface of track 3 is surface roughness TRa, a surface roughness of the side surface of groove 2 is surface roughness SRa, and a surface roughness of the bottom surface of groove 2 is surface roughness BRa, each surface roughness preferably satisfies the following condition. Herein, surface roughness TRa, SRa and BRa are arithmetic average surface roughness Ra of a surface roughness defined by JIS B0601.

Surface roughness TRa<2 nm

Surface roughness SRa<10 nm

Surface roughness BRa<10 nm

It is possible to secure good smoothness on the track surface and to provide good recording characteristics, by satisfying the above condition by each surface roughness. Further, it is possible to provide a magnetic recording medium exhibiting chemical stability and high reliability even after a treatment of a recording layer or a cover layer following to a groove processing, by providing an appropriate smoothness to an exposed substrate surface other than tracks.

Herein, surface roughness TRa, surface roughness SRa and surface roughness BRa preferably satisfy the relationship of following equation (4).

TRa<SRa<BRa Equation (4)

By satisfying the relationship of equation (4), it is possible to secure a track surface having excellent magnetic characteristics as well as to easily fabricate a molding die having high precision which is necessary for the ultra-fine groove processing. Further, productivity of a substrate can be improved due to improvement of pattern transfer property at the groove processing.

Further, groove 2 may be divided by a predetermined rough pattern at a predetermined position in the circumferential direction of substrate made of resin 1. This rough pattern corresponds to, for example, a servo region. Since groove 2 and the rough pattern corresponding to a servo region are molded in one-shot by fabricating substrate made of resin 1 by means of such as an extrusion molding method, it is possible to reduce the fabrication processes of magnetic recording medium.

Further, surface winding value Wa (constituted of frequency components of not shorter than 1 mm) of the whole surface of substrate made of resin 1 is preferably not more than 30 Å, and surface micro winding value MWa (constituted of frequency components of not shorter than 1 μm and not longer than 1 mm) of the whole surface of substrate made of resin 1 is preferably not more than 15 Å. Herein, the surface winding is defined by JIS B 0610-1987.

Herein winding is one type of a substrate surface shape and corresponds to a shape factor having larger frequency than a roughness component. Winding Wa utilized here means a shape constituted of frequency components of not shorter than 1 mm. Further, a shape constituted of frequency components of not shorter than 1 μm and not longer than 1 mm based on a wavelength of frequency is called as micro winding MWa, and said micro winding is generated over the aforesaid winding.

“Winding (flatness)” is measured by optical interference (Newton ring), and a deviation amount of a practical surface and a standard surface is measured as interference fringes. Height of micro winding is usually measured by use of Multifunctional Disk Interference Meter (Optiflat) manufactured by Phase Shift Technology, Inc. The principle of the measurement is a method to measure micro shape deformation on the surface by irradiating the surface of a glass plate and measuring intensity change of interference between a reference light and a measured light having different phases. The obtained data from which frequencies not shorter than 1 mm are cut is generally defined as a height of micro winding

An excellent groove processed pattern as a whole substrate can be obtained by satisfying a condition comprising winding Wa of not longer than 30 Å and micro-winding of not longer than 15 Å, whereby it is possible to provide a magnetic recording medium having an excellent magnetic characteristics at the time of recording and reproduction.

Further, the above explanation has been made with respect to an example in which a substrate is constituted of single resin; however, the substrate is not limited those constituted of single resin but may be constituted of a non-magnetic material such as metal or glass the surface of which is covered with a resin layer. In this case, as a non-magnetic material to be covered with resin, various raw materials which are applicable for a substrate such as resin, metal, glass, glass ceramics or an organic inorganic complex material can be utilized.

Herein, it is more preferable that a substrate is constituted of single resin because of an effect to make the fabrication process simpler.

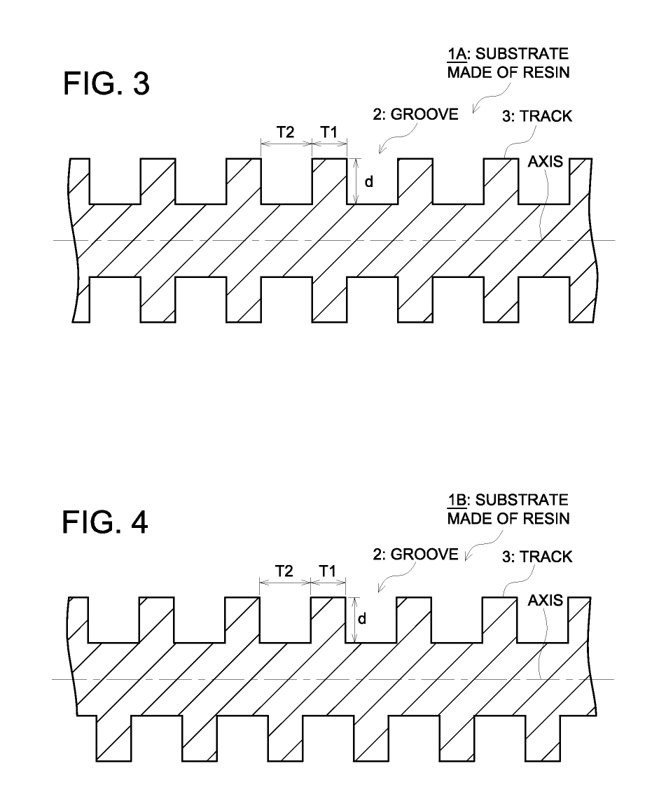

Next, a substrate to be included in a magnetic recording medium according to modified examples of the above-described embodiment will be explained in reference to FIGS. 3-7. FIGS. 3-7 are cross-sectional views of a substrate to be included in a magnetic recording medium according to modified examples.

### Modified Example 1

Modified example 1 will now be explained in reference to FIGS. 3 and 4. Groove 2 was formed only on the one surface of substrate made of resin 1 shown in FIG. 1; however, grooves 2 may be formed on the both surfaces. For example, as shown in the cross-sectional view of FIG. 3, grooves 2 are formed on the both surfaces of substrate made of resin 1. Grooves 2 on the both surfaces are formed at the symmetric positions against the center of thickness direction of substrate made of resin 1 as an axis. Further, as substrate made of resin 1B shown in the cross-sectional view of FIG. 4, grooves 2 may be formed on the both surfaces of substrate made of resin 1. Grooves 2 on the both surfaces may be formed at the asymmetric positions against the center of thickness direction of substrate made of resin 1B as an axis.

Even in the case of grooves being formed on the both surfaces, by satisfying the relationship of above-described equation (1), it is possible to fabricate a magnetic recording medium having a sufficient recording density and in/from which data can be written and read stably, and in addition to this by satisfying the relationship of above-described equation (2), it is possible to secure an excellent productivity and to write-in and read-out data more stably.

Further, in the case of forming a rough pattern corresponding to a servo region, the rough patterns formed on the both surfaces may be at either symmetric or asymmetric positions against the center of thickness direction of a substrate made of resin as an axis.

### Modified Example 2

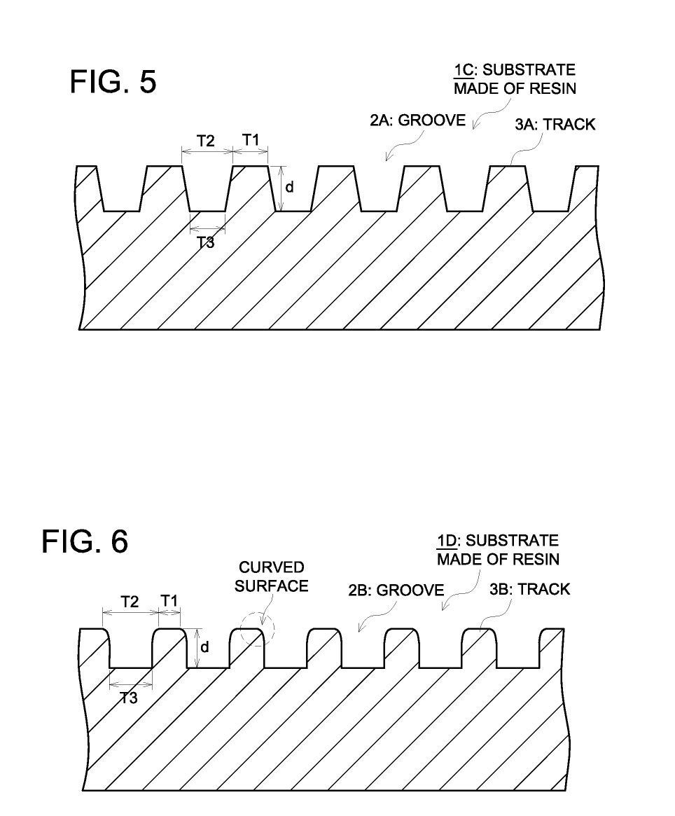

Next, modified example 2 will be explained in reference to FIG. 5. In this substrate made of resin 1C according to modified example 2, the side surface of groove 2A is obliquely formed against the top surface of track 3A (the surface of substrate made of resin 1C) and a width of groove 2A is gradually narrowed toward the interior (the depth direction) from the surface of substrate made of resin 1C.

Herein, a width of the top surface of track 3A (uppermost width) is T₁; a width of the upper part of groove 2A is T₂; a width of the bottom surface of groove 2A is T₃; and a depth of groove 2A is d. Also in this modified example 2, width T₁ of the top surface of track 3A (uppermost width) and width T₂ of the upper part of groove 2A satisfy the relationship of above-described equation (1). Thereby, in the case of forming a magnetic layer or a cover layer on the surface of substrate made of resin 1C, groove 2A is never embedded with a magnetic layer or a cover layer and it is possible to fabricate a magnetic recording medium from/in which data is read or written stably.

Further, width T₃ of the top surface of groove 2A and depth d of groove 2A preferably satisfy the relationship of above-described equation (2). Thereby, it is possible to stably perform read-out and write-in of data

Further, in this modified example 2, width T₂ of the upper part of groove 2A and width T₃ of the bottom surface of groove 2A satisfy the relationship of following equation (5).

T₃≦T₂ Equation (5)

As described above, by making a width of the upper part of not less than a width of the bottom surface and making a width of groove 2A constant or narrower from the surface to the interior (to the depth direction) of substrate made of resin 1C, it is possible to improve transfer precision of a groove shape in the case of extrusion molding by use of a molding die.

Further, an inclination angle of the side surface of groove 2A is preferably 45-90 degree. Separation effect cannot be sufficiently exhibited when an inclination angle is less than 45 degree and it is difficult to stably perform read-out and write-in of data, which are essential purposes, in a magnetic recording medium employing a substrate having an inclination angle of less than 45 degree. Further, when the inclination angle exceeds 90 degree, the mass productivity in a groove manufacturing process significantly decreases to make it difficult to provide a magnetic recording medium having excellent characteristics at a low cost.

Herein, groove 2A may be formed on the both surfaces of substrate made of resin 1C similar to substrate 1A and 1B according to modified example 1. Grooves 2A may be formed at positions symmetric against the center of the thickness direction of substrate made of resin 1C or may be formed at asymmetric positions.

### Modified Example 3

Next, modified example 3 will be explained in reference to FIG. 6. In this substrate made of resin 1D according to modified example 3, the side surface of groove 2B is formed in a curved surface form and the outermost surface of track 3B is tapered off. In this manner, by making a curved surface form of the side surface of groove 2B, it is possible to prevent the contact between magnetic layers on tracks 3B adjacent each other. Further, in the case that a magnetic head contacts with a magnetic recording medium surface due to some factor at the time of HDD being mounted, obtained can be an effect to reduce damage, which the magnetic head receives, owing to the edge portion of a groove. With respect to the side surface of a curved surface form, a certain effect can be obtained even when only one side is a curved surface form.

Further, the side surface of a curved surface form may be either a convex surface form or a concave surface form.

Herein, a width of the top surface of track 3B (uppermost width) is T₁; a width of the upper part of groove 2B is T₂; a width of the bottom surface of groove 2B is T₃; and a depth of groove 2B is d. Also in this modified example 3, width T₁ of the top surface of track 3B and width T₂ of the upper part of groove 2B satisfy the relationship of above-described equation (1). Thereby, in the case of forming a magnetic layer or a cover layer on the surface of substrate made of resin 1D, groove 2B is never embedded with a magnetic layer or a cover layer and it is possible to fabricate a magnetic recording medium from/in which data is read or written stably.

Further, width T₁ of track 3B and depth d of groove 2B preferably satisfy the relationship of equation (2) described above. Thereby, it is possible to stably perform read-out and write-in of data.

Further, width T₂ of the upper part of groove 2B and width T₃ of the bottom surface of groove 2B preferably satisfy the relationship of equation (5) described above. Thereby, it is possible to improve transfer precision of a groove shape in the case of extrusion molding by use of a molding die.

Herein, groove 2B may be formed on the both surfaces of substrate made of resin 1D similar to substrate 1A and 1B according to modified example 1. Grooves 2B may be formed at positions symmetric against the center of the thickness direction of substrate made of resin 1D as an axis or may be formed at asymmetric positions.

### Modified Example 4

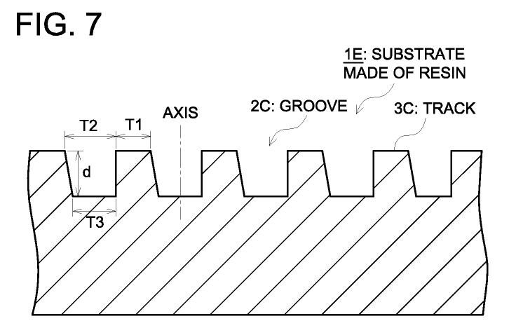

Next, modified example 4 will be explained in reference to FIG. 7. In substrate made of resin 1E according to this modified example 4, a shape of the cross-section of groove 2C is asymmetric against an axis passing through the center of the bottom surface of groove 2C. For example, one side surface of groove 2C is vertically formed while the other side surface is obliquely formed to make the cross section of groove 2C to be an asymmetric shape. By making the cross sectional shape of groove 2C being asymmetric, a molding die can be easily fabricated by use of a relatively simple tool such as a grinding bite. Further, improved is mold releasing property at the time of molding of substrate made of resin 1E by means of an extrusion molding employing a molding die, which enables relatively easy fabrication.

Further, a width of groove 2C is made gradually narrower from the surface toward the interior (the depth direction) of substrate made of resin 1E.

Herein, a width of the top surface of track 3c (uppermost width) is T₁; a width of the upper part of groove 2C is T₂; a width of the bottom surface of groove 2C is T₃; and a depth of groove 2C is d. Also in this modified example 4, width T₁ of the top surface of track 3C and width T₂ of the upper part of groove 2C satisfy the relationship of above-described equation (1). Thereby, in the case of forming a magnetic layer or a cover layer on the surface of substrate made of resin 1E, groove 2C is never embedded with a magnetic layer or a cover layer and it is possible to fabricate a magnetic recording medium from/in which data is read or written stably.

Further, width T₁ of the top surface of track 3C and depth d of groove 2C preferably satisfy the relationship of equation (2) described above. Thereby, it is possible to stably perform read-out and write-in of data.

Further, in this modified example 4, width T₂ of the upper part of groove 2C and width T₃ of the bottom surface of groove 2C preferably satisfy the relationship of equation (5) described above. Thereby, it is possible to improve transfer precision of a groove shape in the case of extrusion molding by use of a molding die.

Herein, groove 2C may be formed on the both surfaces of substrate made of resin 1E similar to substrate 1A and 13 according to modified example 1. Grooves 2C may be formed at positions symmetric against the center of the thickness direction of substrate made of resin 1E as an axis or may be formed at asymmetric positions.

### EXAMPLES

Next, specific examples according to embodiments of the invention will be explained.

### Example 1

In this example 1, a specific example of substrate made of resin 1 will be explained. In this example 1, groove 2 was formed on one surface of substrate made of resin 1 as shown in FIG. 1.

(Molding of Substrate Made of Resin 1)

Utilizing polyimide as a material of a substrate, substrate made of resin 1 was fabricated by extrusion molding. Aurum (manufactured by Mitsui Chemicals, Inc.) was utilized as polyimide. The dimension of this substrate made of resin 1 will be shown below.

Outer diameter: 1 inch (25.4 mm)

Thickness of substrate made of resin 1: 0.4 mm

Width of track 3, T₁: 0.1 μm

Width of groove 2, T₂: 0.05 μm

Depth of groove 2, d: 0.025 μm

Surface roughness of the top surface of track 3, TRa: 0.8 nm

Surface roughness of the side surface of groove 2, SRa: 1.2 nm

Surface roughness of the bottom surface of groove 2, BRa: 1.5 nm

In this example 1, width T₁ of track 3 and width T₂ of groove 2 satisfy the relationship of equation (1): T₂/5<T₁<5T₂. Further, width T₁ of track 3 and depth d of groove 2 satisfy the relationship of equation (2): d/5 T₁<5d. Further, surface roughness on each surface satisfies the relationship of equation (4): TRa<SRa≦BRa.

By extrusion molding utilizing resin in this manner, substrate made of resin 1, in which grooves have been formed by a simple method, can be fabricated. Thereby, in fabrication of a DT medium, it is not necessary to conduct patterning of a soft magnetic layer or a magnetic layer, which will be accumulated on a substrate made of resin, by a method such as a nano-inprint method. Since such a complex process is not necessary, it is possible to fabricate a magnetic recording medium in a process number less than conventional process.

(Formation of Cover Layer)

Above-described substrate made of resin 1 having been provided with groove 2 was subjected to spattering to form a Ni layer having a thickness of 10 nm on the surface of substrate made of resin 1. Then, by continuous spattering, a NiP alloy layer (hereinafter, abbreviated as a NiP layer) was formed on the Ni layer. The thickness of this NiP layer was 10 nm. These Ni layer and NIP layer correspond to a cover layer formed on substrate made of resin 1.

After a cover layer had been formed, a magnetic layer comprising Co type alloy was formed on the cover layer by spattering, whereby a magnetic recording medium was prepared.

Thickness of magnetic layer: 80 nm

(Evaluation)

After a magnetic layer had been formed on substrate made of resin 1, the state of a magnetic layer and a cover layer in groove 2 was observed. In this example 1, it has been confirmed that a magnetic layer and a cover layer on tracks 3 adjacent each other were never brought in contact, and that groove 2 was not embedded with a magnetic layer or a cover layer. In this manner, by satisfying the relationship of equation (1), it was possible to physically separate tracks 3. And, by employing this substrate made of resin 1, it is possible to fabricate a magnetic recording medium from/in which data can be read and written stably.

Herein, polyimide was utilized as a material of substrate made of resin 1 in this example 1; however, a similar effect can be achieved by employing other resin listed in the above-described embodiment. Further, a NiP layer was utilized as a cover layer; however, a similar effect can be achieved by accumulating a layer comprising other components.

Further, in this example 1, an example in which groove 2 was formed only on one surface of substrate made of resin 1 was explained; however, it has been proved that groove 2 was never embedded with a magnetic layer or a cover layer similar to this example 1, even when groove 2 was formed on the both surfaces as shown in modified example 1 and modified example 2.

### Example 2

In this example 2, a specific example of substrate made of resin 1 shown in FIG. 1 will be explained similar to example 1. In this example 2, groove 2 was formed on one surface of substrate made of resin 1 similar to example 1. In this example 2, width T₂ was made broader than that of example 1. Herein, in substrate made of resin 1 according to this example 2, the same resin (polyimide) was utilized similar to example 1.

(Dimension of Substrate Made of Resin 1)

Outer diameter: 1 inch (25.4 mm)

Thickness of substrate made of resin 1: 0.4 mm

Width of track 3, T₁: 0.03 μm

Width of groove 2, T₂: 0.1 μm

Depth of groove 2, d: 0.05 μm

Surface roughness of the top surface of track 3, TRa: 0.5 nm

Surface roughness of the side surface of groove 2, SRa: 1.0 nm

Surface roughness of the bottom surface of groove 2, BRa: 2.0 nm

In this example 2, width T₁ of track 3 and width T₂ of groove 2 satisfy the relationship of equation (1): T₂/5<T₁<5T₂. Further, width T₁ of track 3 and depth d of groove 2 satisfy the relationship of equation (2): d/5<T₁<5d. Further, surface roughness on each surface satisfies the relationship of equation (4): TRa<SRa≦BRa.

(Formation of Cover Layer)

Also in this example 2, a Ni layer and a Nip layer were formed on substrate made of resin 1 as cover layers similar to example 1, and a magnetic layer comprising Co type alloy was formed on said cover layer by spattering, whereby a magnetic recording medium was fabricated.

Thickness of magnetic layer: 100 nm

(Evaluation)

After a magnetic layer had been formed on substrate made of resin 1, the state of a magnetic layer and a cover layer in grooves 2 was observed. In this example 2, similar to example 1, it has been confirmed that a magnetic layer and a cover layer on adjacent tracks 3 are never brought in contact each other and that groove 2 is not embedded with a magnetic layer or a cover layer.

Further, it has been proved that groove 2 is not embedded with a magnetic layer or a cover layer even in the case of forming groove 2 on the both surfaces of substrate made of resin 1.

### Example 3

In this example 3, a specific example of substrate made of resin 1 shown in FIG. 1 will be explained similar to example 1. In this example 3, groove 2 was formed on one surface of substrate made of resin 1. In this example 3, depth d of groove 2 is deeper than example 1. Resin same as example 1 (polyimide) was utilized in substrate made of resin 1 according to this example 3.

(Dimension of Substrate Made of Resin 1)

Outer diameter: 1 inch (25.4 mm)

Thickness of substrate made of resin 1: 0.4 mm

Width of track 3, T₁: 0.1 μm

Width of groove 2, T₂: 0.05 μm

Depth of groove 2, d: 0.08 μm

Surface roughness of the top surface of track 3 TRa: 1.0 nm

Surface roughness of the side surface of groove 2 SRa: 4.5 nm

Surface roughness of the bottom surface of groove 2 BRa: 4.5 nm

In this example 3, width T₁ of track 3 and width T₂ of groove 2 satisfy the relationship of equation (1): T₂/5<T₁<5T₂. Further, width T₁ of track 3 and depth d of groove 2 satisfy the relationship of equation (2): d/5<T₁<5d. Further, surface roughness on each surface satisfies the relationship of equation (4): TRa<SRa≦BRa.

(Formation of Cover Layer)

Also in this example 3, a Ni layer and a Nip layer were formed on substrate made of resin 1 as cover layers similar to example 1. Thickness of each layer is same as example 1. And a magnetic layer comprising Co type alloy was formed on said cover layer by spattering, whereby a magnetic recording medium was fabricated.

Thickness of magnetic layer: 80 nm

(Evaluation)

After a magnetic layer had been formed on substrate made of resin 1, the state of a magnetic layer and a cover layer in grooves 2 was observed. In this example 3, similar to example 1, it has been confirmed that a magnetic layer and a cover layer on adjacent tracks 3 were never brought in contact each other and that groove 2 was not embedded with a magnetic layer or a cover layer.

Further, it has been proved that groove 2 is not embedded with a magnetic layer or a cover layer even in the case of forming groove 2 on the both surfaces of substrate made of resin 1.

### Example 4

In this example 4, a specific example of substrate made of resin 1C (modified example 2) shown in FIG. 5 will be explained. In this example 4, groove 2A was formed on one surface of substrate made of resin 1C as shown in FIG. 5. Herein, resin same as example 1 (polyimide) was utilized in substrate made of resin 1C according to this example 4.

(Dimension of Substrate Made of Resin 1C)

Outer diameter: 1 inch (25.4 mm)

Thickness of substrate made of resin 1C: 0.4 mm

Width of the top surface (the outermost surface) of track 3A, T₁: 0.025 μm

Width of the upper part of groove 2A, T₂: 0.02 μm

Width of the bottom surface of groove 2A, T₃: 0.015 μm

Depth of groove 2A, d: 0.08 μm

Surface roughness of the top surface of track 3A, TRa: 1.2 nm

Surface roughness of the side surface of groove 2, SRa: 3.0 nm

Surface roughness of the bottom surface of groove 2, BRa: 9.0 nm

In this example 4, width T₁ of track 3A and width T₂ of groove 2 satisfy the relationship of equation (1): T₂/5<T₁<5T₂. Further, width T₁ of the top surface (the outermost surface) track 3A and depth d of groove 2 satisfy the relationship of equation (2): d/5<T₁<5d. Further, width T₂ of the upper part of groove 2A and width T₃ of the bottom surface of groove 2 satisfy the relationship of equation (5). Further, surface roughness on each surface satisfies the relationship of equation (4): TRa<SRa≦BRa.

(Formation of Cover Layer)

Also in this example 4, a Ni layer and a Nip layer were formed on substrate made of resin 1C as cover layers similar to example 1. Thickness of each layer is same as example 1. And a magnetic layer comprising Co type alloy was formed on said cover layer by spattering, whereby a magnetic recording medium was fabricated.

Thickness of magnetic layer: 200 nm

(Evaluation)

After a magnetic layer had been formed on substrate made of resin 1C, the state of a magnetic layer and a cover layer in grooves 2 was observed. In this example 4, similar to example 1, it has been confirmed that a magnetic layer and a cover layer on adjacent tracks 3 were never brought in contact each other and that groove 2 was not embedded with a magnetic layer or a cover layer. Further, transfer precision of a groove shape from a molding die was improved. In this manner, transfer precision of a groove shape from a molding die has been improved by satisfying the relationship of equation (5).

### Example 5

In this example 5, similar to example 4, a specific example of substrate made of resin 1C (modified example 2) shown in FIG. 5 will be explained. In this example 5, similar to example 4, groove 2 was formed on one surface of substrate made of resin 1C. In this example 5, width T₂ of the upper part of groove 2A was made wider than example 4. Herein, resin same as example 1 (polyimide) was utilized in substrate made of resin 1C according to this example 5.

(Dimension of Substrate Made of Resin 1C)

Outer diameter: 1 inch (25.4 mm)

Thickness of substrate made of resin 1: 0.4 mm

Width of top surface (outermost surface) of track 3A, T₁: 0.025 μm

Width of upper part of groove 2A, T₂: 0.025 μm

Width of bottom surface of groove 2A, T₃: 0.015 μm

Depth of groove 2A, d: 0.02 μm

Surface roughness of top surface of track 3A, TRa: 0.8 nm

Surface roughness of side surface of groove 2, SRa: 1.5 nm

Surface roughness of bottom surface of groove 2, BRa: 3.0 nm

In this example 5, width T₁ of the top surface of track 3A and width T₂ of the upper surface of groove 2A satisfy the relationship of equation (1): T₂/5<T₁<5T₂. Further, width T₁ of the top surface (the outermost surface) of track 3A and depth d of groove 2 satisfy the relationship of equation (2): d/5<T₁<5d. Further, width T₂ of the upper part of groove 2A and width T₃ of bottom surface of groove 2 satisfy the relationship of equation (3): width T₃≦width T₂. Further, surface roughness on each surface satisfies the relationship of equation (4): TRa<SRa≦BRa.

(Formation of Cover Layer)

Also in this example 5, a Ni layer and a Nip layer were formed on substrate made of resin 1C as cover layers similar to example 1. Thickness of each layer is same as example 1. And a magnetic layer comprising Co type alloy was formed on said cover layer by spattering, whereby a magnetic recording medium was fabricated.

Thickness of magnetic layer: 50 nm

(Evaluation)

After a magnetic layer had been formed on substrate made of resin 1C, the state of a magnetic layer and a cover layer in grooves 2 was observed. In this example 5, similar to example 1, it has been confirmed that a magnetic layer and a cover layer on adjacent tracks 3 were never brought in contact each other and that groove 2 was not embedded with a magnetic layer or a cover layer. Further, transfer precision of a groove shape from a molding die was improved.

### Example 6

In this example 6, a specific example of substrate made of resin 1C (modified example 3) shown in FIG. 6 will be explained. In this example 6, as shown in FIG. 6, groove 2B was formed on one surface of substrate made of resin 1D and the side surface of groove 2B was made into a curved shape. Whereby, the part of the outermost surface of track 3 was made into a tapered shape. Herein, resin same as example 1 (polyimide) was utilized in substrate made of resin 1C according to this example 6.

(Dimension of Substrate Made of Resin 1D)

Outer diameter: 1 inch (25.4 mm)

Thickness of substrate made of resin 1: 0.4 mm

Width of top surface (outermost surface) of track 3B, T₁: 0.05 μm

Width of upper part of groove 2A, T₂: 0.20 μm

Width of bottom surface of groove 2A, T₃: 0.10 μm

Depth of groove 2A, d: 0.08 μm

Surface roughness of top surface of track 3A, TRa: 1.5 nm

Surface roughness of side surface of groove 2, SRa: 9.0 nm

Surface roughness of bottom surface of groove 2, BRa: 9.0 nm

In this example 6, width T₁ of the top surface of track 3B and width T₂ of the upper surface of groove 2B satisfy the relationship of equation (1): T₂/5<T₁<5T₂. Further, width T₁ of the top surface (the outermost surface) of track 3A and depth d of groove 2 satisfy the relationship of equation (2): d/5<T₁<5d. Further, width T₂ of the upper part of groove 2B and width T₃ of the bottom surface of groove 2 satisfy the relationship of equation (5): width T₃≦width T₂. Further, surface roughness on each surface satisfies the relationship of equation (4): TRa<SRa≦BRa.

(Formation of Cover Layer)

Also in this example 6, a Ni layer and a NiP layer were formed on substrate made of resin 1D as cover layers similar to example 1. Thickness of each layer is same as example 1. And a magnetic layer comprising Co type alloy was formed on said cover layer by spattering, whereby a magnetic recording medium was fabricated.

Thickness of magnetic layer: 100 nm

(Evaluation)

After a magnetic layer had been formed on substrate made of resin 1D, the state of a magnetic layer and a cover layer in grooves 2 was observed. In this example 5, similar to example 1, it has been confirmed that a magnetic layer and a cover layer on adjacent tracks 3B were never brought in contact each other and that groove 2 was not embedded with a magnetic layer or a cover layer. Further, it is possible to prevent contact of a magnetic layer and a cover layer on adjacent tracks 3B each other by making the side surface of groove 2B into a curved shape and the outermost surface of track 3 into a tapered shape.

### Example 7

In this example 7, a specific example of substrate made of resin 1E (modified example 4) shown in FIG. 7 will be explained. In this example 7, as shown in FIG. 7, groove 2B was formed on one surface of substrate made of resin 1E. Herein, resin same as example 1 (polyimide) was utilized in substrate made of resin 1E according to this example 7 similar to example 1.

(Dimension of Substrate Made of Resin 1E)

Outer diameter: 1 inch (25.4 mm)

Thickness of substrate made of resin 1: 0.4 mm

Width of top surface (outermost surface) of track 3C, T₁: 0.02 μm

Width of upper part of groove 2A, T₂: 0.015 μm

Width of bottom surface of groove 2A, T₃: 0.01 μm

Depth of groove 2A, d: 0.01 μm

Surface roughness of top surface of track 3A, TRa: 1.5 nm

Surface roughness of side surface of groove 2, SRa: 2.5 nm

Surface roughness of bottom surface of groove 2, BRa: 5.0 nm

In this example 7, width T₁ of the top surface (the outermost surface) of track 3C and width T₂ of the upper surface of groove 2C satisfy the relationship of equation (1): T₂/5<T₁<5T₂. Further, width T₁ of the top surface (the outermost surface) of track 3A and depth d of groove 2 satisfy the relationship of equation (2): d/5<T₁<5d. Further, surface roughness on each surface satisfies the relationship of equation (4): TRa<SRa≦BRa. Further, width T₂ of the upper part of groove 2C and width T₃ of the bottom surface of groove 2C satisfy the relationship of equation (5): width T₃≦width T₂. Further, groove 2C was formed so that the cross-section shape of groove 2C is asymmetric against an axis passing through the center of the bottom surface of groove 2C.

(Formation of Cover Layer)

Also in this example 7, a Ni layer and a NiP layer were formed on substrate made of resin 1E as cover layers similar to example 1. Thickness of each layer was same as example 1. And a magnetic layer comprising Co type alloy was formed on said cover layer by spattering, whereby a magnetic recording medium was fabricated.

Thickness of magnetic layer: 100 nm

(Evaluation)

After a magnetic layer had been formed on substrate made of resin 1E, the state of a magnetic layer and a cover layer in grooves 2C was observed. In this example 7, similar to example 1, it has been confirmed that a magnetic layer and a cover layer on adjacent tracks 3C were never brought in contact each other and that groove 2C was not embedded with a magnetic layer or a cover layer. Further, molding of substrate made of resin 1E by means of an extrusion molding utilizing a molding die becomes relatively easy.

### Comparative Example

Next, a comparative example against above-described examples 1-7 will be explained. Resin same as such as example 1 (polyimide) was utilized in substrate made of resin according to this comparative example.

(Dimension of Substrate Made of Resin according to Comparative Example)

Outer diameter: 1 inch (25.4 mm)

Thickness of substrate made of resin 1: 0.4 mm

Width of track T₁: 0.1 μm

Width of groove T₂: 0.01 μm

Depth of groove d: 0.01 μm

In this comparative example, width T₁ of track is broader than 5 times of width T₂ of a groove. Further, width T₁ of track is broader than 5 times of depth d of a groove.

(Formation of Cover Layer)

Also in this comparative example, a Ni layer and a NiP layer were formed on substrate made of resin 1E as cover layers similar to example 1. Thickness of each layer was same as such as example 1. And a magnetic layer comprising Co type alloy was formed on said cover layer by spattering, whereby a magnetic recording medium was fabricated.

Thickness of magnetic layer: 80 nm

(Evaluation)

After a magnetic layer had been formed on substrate made of resin 1E, the state of a magnetic layer and a cover layer in grooves 2C was observed. In this comparative example, it has been confirmed that magnetic layers and cover layers on adjacent tracks were brought in contact each other and that a groove was embedded with a magnetic layer or a cover layer. Therefore in a magnetic recording medium utilizing substrate made of resin in comparative example in this manner, it becomes difficult to stably perform read-out and write-in of data.

In the above manner, by a substrate made of resin according to examples 1-7 of this invention, since a groove is never embedded with a cover layer or a magnetic layer, it is possible to stably perform read-out and write-in of data by a magnetic recording medium utilizing the substrate made of resin of examples. On the other hand, by a substrate made of resin according to a comparative example, since a groove is embedded with a cover layer or a magnetic layer, it becomes difficult to stably perform read-out and write-in of data. Therefore, by utilizing a substrate made of resin which satisfies the relationship of “T₂/5<T₁<5T₂” with respect to width T₁ of a track and width T₂ of a groove, a groove is not embedded with a magnetic layer or a cover layer to enable fabrication of a magnetic recording medium in/from which data can be written and read stably. Further, by utilizing a substrate made of resin which satisfies the relationship of “d/5<T₁<5d” with respect to width T₁ of a track and depth d a groove, it is possible to fabricate a magnetic recording medium from/in which data can be read and written further stably.

Herein, it has been proved that the same effect as substrate made of resin according to examples 1-7 was exhibited by satisfying the relationship of “T₂/5<T₁<5T₂” and the relationship of “d/5<T₁<5d” even with a substrate made of resin prepared under a different condition other than those explained in examples 1-7.

### Example 8

### Comparative Example

Data was written to magnetic recording media which had been fabricated in examples 1, 2 and 3 and a magnetic recording medium fabricated in a comparative example by use of a magnetic head having a width of a writing line (TW) of 0.1 μm. Any of the combinations of this magnetic head and these magnetic recording media satisfies equation (3): T₁/2<TW<T₁+2T₂. A magnetic recording media fabricated in examples 1-3 exhibited excellent magnetic recording characteristics and enabled stable write-in of data, while a magnetic recording medium fabricated in a comparative example exhibited increased noise to deteriorate recording characteristics.

1-30. (canceled)

31. A substrate to be included in a magnetic recording medium having a disc form and a surface of the substrate is made of a resin, the substrate comprising:
a non-magnetic material as a base material; wherein
a plurality of coaxial grooves are formed on the surface, and the plurality of coaxial grooves satisfies the expression
T₂/5<T₁<5T₂
where T₁ is a width of an interval between adjacent grooves of the coaxial grooves and T₂ is a width of each of the coaxial grooves.

32. The substrate to be included in a magnetic recording medium according to claim 31, wherein d/5<T₁<5d is satisfied when a depth of each of the coaxial grooves is d.

33. The substrate to be included in a magnetic recording medium according to claim 31, wherein T₃≦T₂ (herein, T₃=0 is included) is satisfied where a width of an upper part of each of the coaxial grooves is T₂ and a width of a bottom part of each of the coaxial grooves is T₃.

34. The substrate to be included in a magnetic recording medium according to claim 31, wherein the width of each of the coaxial grooves is made gradually narrower from the surface to the interior of the substrate.

35. The substrate to be included in a magnetic recording medium according to claim 31, wherein side surfaces of each of the coaxial grooves is a flat plane crossing straight against the surface of the substrate.

36. The substrate to be included in a magnetic recording medium according to claim 1, wherein at least one side surface of each of the coaxial grooves is inclined with respect to the surface of the substrate.

37. The substrate to be included in a magnetic recording medium according to claim 36, wherein an inclination angle of the inclined side surface is from 45° to 90°.

38. The substrate to be included in a magnetic recording medium according to claim 36, wherein a curved surface is intervened between the side surface of the each of the coaxial grooves and the surface of the substrate.

39. The substrate to be included in a magnetic recording medium according to claim 31, wherein the side surface of each of the coaxial grooves has a curved surface form.

40. The substrate to be included in a magnetic recording medium according to claim 39, wherein the side surface having a curved surface form is a curved surface having a convex surface form.

41. The substrate to be included in a magnetic recording medium according to claim 39, wherein the side surface having a curved surface form is a curved surface having a concave surface form.

42. The substrate to be included in a magnetic recording medium according to claim 31, wherein T₁/2<TW<T₁+2T₂ is satisfied in a magnetic recording device mounted with the substrate when a line width of a writing line of a magnetic head equipped in the magnetic recording device is TW.

43. The substrate to be included in a magnetic recording medium according to claim 31, wherein the coaxial grooves are divided by a predetermined uneven pattern at a predetermined position in a circumferential direction of the substrate.

44. The substrate to be included in a magnetic recording medium according to claim 43, wherein grooves and uneven patterns are formed on the both surfaces of the substrate.

45. The substrate to be included in a magnetic recording medium according to claim 44, wherein the grooves and the uneven patterns, which are formed on the both surfaces of the substrate, are formed at symmetric positions with respect to a center in a thickness direction of the substrate as an axis.

46. The substrate to be included in a magnetic recording medium according to claim 44, wherein positions of the grooves and the uneven patterns, which are formed on the both surfaces of the substrate, coincide.

47. The substrate to be included in a magnetic recording medium according to claim 44, wherein the grooves and the uneven patterns, which are formed on the both surfaces of the substrate, are formed at asymmetric positions with respect to a center in a thickness direction of the substrate as an axis.

48. The substrate to be included in a magnetic recording medium according to claim 44, wherein positions of the grooves and the uneven patterns, which are formed on the both surfaces of the substrate, do not coincide.

49. The substrate to be included in a magnetic recording medium according to claim 31, wherein the substrate satisfies the expression
TRa<SRa≦BRa
where TRa is a surface roughness at a place between the coaxial grooves, SRa is a surface roughness on the side surface of the coaxial grooves and BRa is a surface roughness at the bottom of the coaxial grooves.

50. The substrate to be included in a magnetic recording medium according to claim 49, wherein the substrate satisfies the expression
TRa<2 nm, SRa<10 nm and BRa<10 nm.

51. The substrate to be included in a magnetic recording medium according to claim 31, wherein cross-sectional form of each of the coaxial grooves is asymmetric against an axis passing through a center of the each groove.

52. The substrate to be included in a magnetic recording medium according to claim 31, wherein a waviness value Wa of the surface of the substrate is not more than 30 Å.

53. The substrate to be included in a magnetic recording medium according to claim 31, wherein a micro-waviness value MWa of the surface of the substrate is not more than 30 Å.

54. The substrate to be included in a magnetic recording medium according to claim 31, wherein the coaxial grooves are formed by a molding method.

55. The substrate to be included in a magnetic recording medium according to claim 31, wherein the coaxial grooves are formed by a patterning method.

56. The substrate to be included in a magnetic recording medium according to claim 31, wherein a cover layer of not less than 10 nm and not more than 300 nm is formed on the substrate.

57. The substrate to be included in a magnetic recording medium according to claim 56, wherein the substrate satisfies the expression
Tc<3d
where Tc is a thickness of a cover layer and d is a depth of each of the coaxial grooves.

58. The substrate to be included in a magnetic recording medium according to claim 31, wherein the non-magnetic material as the base material is comprised of resin.

59. The substrate to be included in a magnetic recording medium according to claim 31, wherein the non-magnetic material as the base material is comprised of glass or a non-magnetic metal material.

60. A magnetic recording medium, comprising: the substrate to be included in a magnetic recording medium of claim 31; and a magnetic layer accumulated on the substrate.
